(19) United States
(12) Patent Application Publication
(10) Pub. No.: US 2008/0209120 A1
(43) Pub. Date: Aug. 28, 2008

(54) Accelerating cache performance by active cache validation

(75) Inventors: Itai Almog, Tel-Aviv (IL); Nir Nice, Kfar Vradim (IL)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/710,763

(22) Filed: Feb. 26, 2007

(51) Int. Cl. G06F 13/00

(52) U.S. Cl. 711/106

(57) ABSTRACT

Described is a technology by which a web proxy server evaluates its cached objects, and when an object is invalid, performs a freshness check on that object, independent of any client requests. As a result, the cache contains objects that have a greater likelihood of being fresh when requested by a client. By scanning a web cache data structure to determine whether corresponding cached content is still valid, and sending a freshness check to a web server when the content is not valid, the cache is kept up to date. The scanning may be periodic or based upon some other triggering event, and all of the cache's corresponding entries may be scanned, or some smaller subset of the entries. In one example implementation, a web proxy server that contains the cache includes a freshness check mechanism that scans and keeps the cached objects up to date.

### BACKGROUND

One type of web proxy product accelerates clients' access to web content via web caching. In general, these products cache web objects that were returned to clients, and use those cached objects for subsequent client requests, thereby saving the expense of making additional calls to the web server that provides the content.

However, sometimes when a requested object exists in the cache, the object is not valid to be served as a result of it being too old, as indicated by a timestamp. In this manner, users are protected against being served content that is obsolete, as generally determined by the website designer, e.g., a news site may only allow certain content to be considered valid in a cache for a few minutes, whereas a page that is changed weekly may allow its objects to be cached until the next weekly change.

When an object is too old, the web proxy performs a “freshness” check, by sending a special HTTP request to the web server. If the object is still valid, the server returns a new timestamp for the object, otherwise the server returns the entire object that has changed. The process of freshness checking and possible object downloading to update the cache can be time consuming, particularly in high latency situations in which the connection between the web proxy and remote web server is slow.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a web proxy server performs freshness checks on its cached objects, independent of any client requests, whereby the cache contains objects that have a greater likelihood of being fresh when requested by a client. By evaluating data in a web cache data structure to determine whether content in a web cache corresponding to that data is still valid, and sending a freshness check to a web server when the content is not valid, the cache is kept up to date. The scanning may be periodic or on some other triggering event, and all of the cache's corresponding entries may be scanned, or some smaller subset thereof.

In one example implementation, a web proxy server that receives requests from a client for content directed towards a web server includes a freshness check mechanism. The freshness check mechanism evaluates the web proxy server's cached content, and updates the cache with new content (or new freshness data) when invalid content is found in the cache. As a result, the cache, which is used for serving cached content in response to client requests, is updated independent of a pending client request for that content.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a network having a web proxy server with proactive freshness checking.

FIG. 2 is a flow diagram representing example steps taken by a web proxy server to check cached objects for freshness.

FIG. 3 shows an illustrative example of a general-purpose network computing environment into which various aspects of the present invention may be incorporated.

### DETAILED DESCRIPTION

Various aspects of the technology described herein are generally directed towards increasing useful cache hits in a web proxy server by proactively working to keep cached content valid, rather than reactively in response to a client request. This eliminates or dramatically reduces the number of times the web proxy server needs to perform a freshness check on behalf of a waiting client.

In one example implementation, a freshness checking mechanism of the web proxy server operates in the background, actively scanning the objects stored in the cache engine looking for invalid objects. However, rather than performing an active scan of all objects, it is alternatively feasible to have other triggers, and/or to configure a scanner in numerous ways. For example, a data structure that contains information on the cached objects may be sorted into an event list, with an event that triggers a freshness check on only those objects that have timestamps indicating a freshness check is needed. Alternatively, the objects may be sorted into subsets that are scanned at different frequencies depending on their timestamps, e.g., check one subset every minute, check another subset every half-hour, check another subset every day.

Thus, as will be understood, the technology described herein is not limited to any type of configuration, any type of looping model or any type of event driven model. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and accessing network content in general.

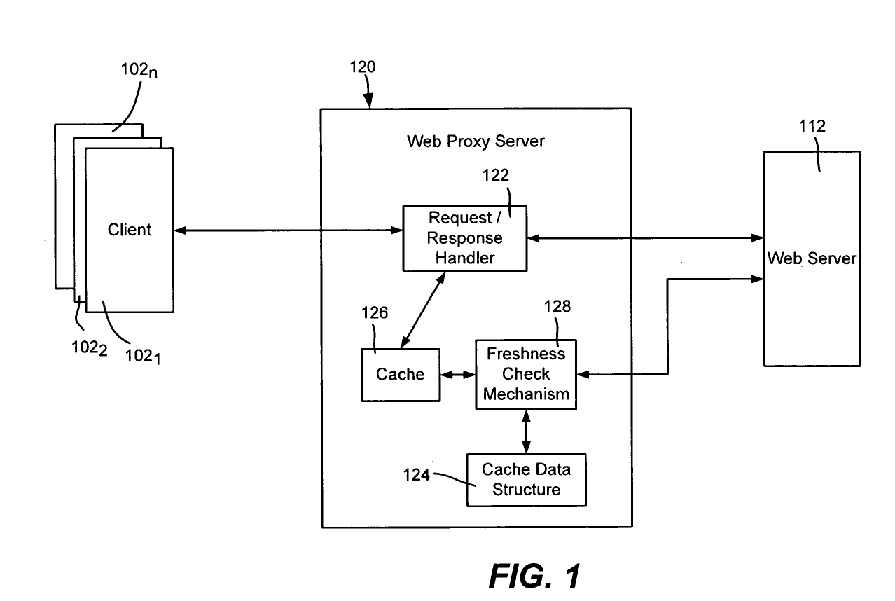

Turning to FIG. 1, there is shown an example network configuration in which clients 102₁-102ₙ issue requests for content to a web server 110. A web proxy server 120 (e.g., an edge server such as an Internet Security and Acceleration, or ISA Server available from Microsoft Corporation), receives the requests from the clients 102₁-102ₙ. The clients 102₁-102ₙ may have no knowledge of the presence of the web proxy server 120, that is, the web proxy server is transparent, although it is feasible to have one or more of the clients 102₁-102ₙ make requests to the web proxy server 120 to perform some operation on behalf of the clients 102₁-102ₙ.

When the web proxy server 120 first receives a web request from the client (e.g., 102₁), a request/response handler 122 in the web proxy server 120 searches a local cache 124 data structure 124 to see if the requested content is cached and still valid. If so, the content (e.g., a main page or an embedded object described thereon) is returned from the cache 126. If not, a freshness check is sent to the web server, to either obtain an updated object or a new timestamp that verifies the object is still valid. This aspect is conventional caching for efficiency purposes.

Rather than wait for a client request before determining whether requested content is valid, the web proxy server 120 includes a freshness check mechanism 128 that operates (without waiting for a client request) to update any invalid objects in the cache 126, either with a new object and associated metadata in the cache data structure 124, or by updating the data structure 124 with changed metadata, including a timestamp indicating the object is still valid. As a result, (and depending on frequency of checking), most objects in the cache 126 are fresh, and can be served from the cache 126 without the need to perform a freshness check while the user is waiting.

Note that what is considered “invalid” need not be the same as actually invalid. For example, if a scan is performed every five minutes, and an object is going to be invalid before the next scan, that object can be considered invalid for purposes of freshness checking. However, the web server may return the same timestamp, in which event the freshness check request is inefficient, and thus a balance between various factors such as scanning frequency, web request latency, client demands and so forth may help decide on whether to consider an almost invalid object as being invalid with respect to sending a freshness check.

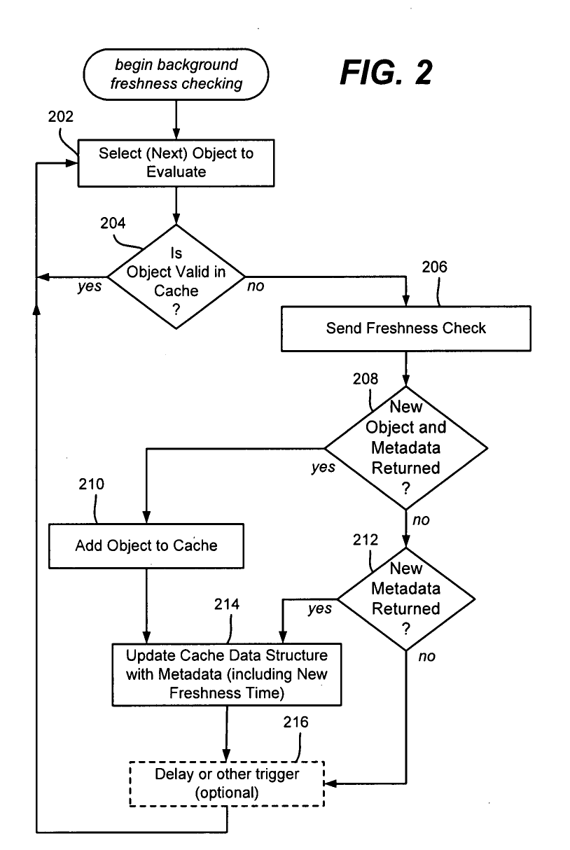

Turning to FIG. 2, the exemplified freshness check mechanism 128 in the web proxy server 120 scans each of the entries (step 202) in the cache data structure 124 looking for invalid entries (step 204). Note that there may be several data structures and/or ways of viewing the data within such a data structure (e.g., by ordering, filtering and/or sorting) that can make this scanning action more efficient. For example, ordering the data structure from the soonest to expire (first) and the longest to expire (last) will send freshness checks in an order that may be more efficient. As another example, ordering and grouping the entries by timestamp can allow selection of a range or ranges of invalid or possibly invalid entries, eliminating the need to individually check the timestamps of known valid entries. Further, HTTP pipelining techniques or the like may be used to efficiently check the status of several web objects at the same time.

Once an invalid entry is detected at step 204, the web proxy initiates a “standard” freshness check at step 206. If a new object and accompanying metadata is returned (step 208), the object is added to the cache at step 210, and the cache data structure (or possibly multiple data structures) updated at step 214 with the changed metadata. Otherwise metadata alone is returned (step 212), whereby the cache data structure is updated at step 214, including to contain the new timestamp. Note that error conditions are not described herein for purposes of simplicity, however it can be understood that retries may be sent following the “no” branch of step 212, and objects and/or metadata that are still not found can be removed from the cache.

Further, it should be noted that the proactive freshness check initiated by the freshness check mechanism 128 is not considered a client request with respect to maintaining the information in the cache. More particularly, because of size limitations, cache management systems remove an object based on when the object was last requested, whereby the cache maintains more recently requested objects over those not requested for some time. Thus, an object request initiated from the freshness check mechanism 128 is not considered as being a client request for that object, otherwise the cache management system would be unable to distinguish which objects are to be kept in the cache based on a recently requested priority.

Step 216 represents delaying, such as to periodically repeat the scan rather than continuously scan. Depending on the scanning frequency, the background freshness checking mechanism may dramatically reduce the number of times a cache entry is requested but it is found to be invalid. Note that the scanning frequency need not be periodic, but can be repeated on any appropriate basis, such as based upon how many users are presently sending web requests, how many entries are in the cache, how quickly or slowly web requests are being handled, and/or virtually any other measurable criteria.

Moreover, as described above, all cache entries may be scanned per scanning process, or a scanning process may alternatively only scan a subset of entries. For example, the timestamps may be used to group entries into subsets so that only entries that have a possibility of being invalid during a scan need to be evaluated.

### Exemplary Operating Environment

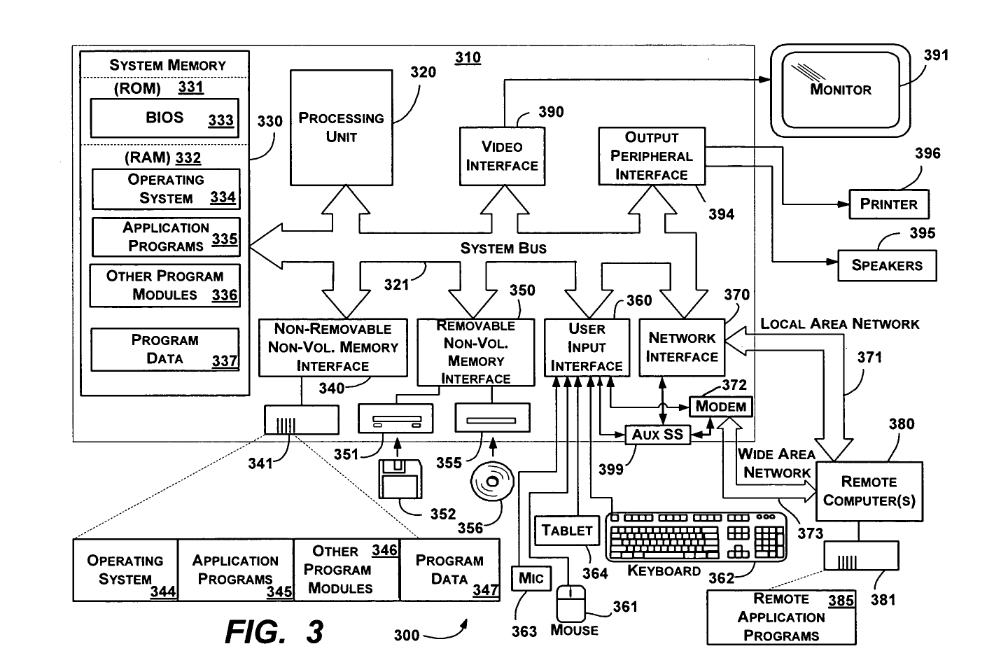

FIG. 3 illustrates an example of a suitable computing system environment 300 on which the web proxy server 120 (FIG. 1) or 121 (FIG. 2) may be implemented, for example. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 3, an exemplary system for implementing various aspects of the invention may include a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer-readable media. Computer-readable media can be any available media that can be accessed by the computer 310 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, described above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as mouse, trackball or touch pad. Other input devices not shown in FIG. 3 may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 395 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include one or more local area networks (LAN) 371 and one or more wide area networks (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component 374 such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application programs 385 as residing on memory device 381. It may be appreciated that the network connections shown are exemplary and other means of establishing a communications link between the computers may be used.

An auxiliary subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
evaluating data in a web cache data structure to determine whether content in a web cache corresponding to that data is still valid, independent of a pending client request for content corresponding to that data; and
when the content is not valid, sending a freshness check to a web server to update the data in the web cache data structure, or to update the content in the cache and the data in the web cache data structure.

2. The method of claim 1 wherein the content comprises a plurality of objects in the cache, wherein the web cache data structure contains data comprising an entry for each cached object, and wherein evaluating the data comprises periodically scanning the entries.

3. The method of claim 1 wherein the content comprises a plurality of objects in the cache, wherein the web cache data structure contains data comprising an entry for each cached object, and wherein evaluating the data comprises scanning a subset of the entries.

4. The method of claim 1 wherein the content comprises a plurality of objects in the cache, wherein the web cache data structure contains data comprising an entry for each cached object, and wherein evaluating the data comprises scanning at least some of the entries upon a triggering event.

5. The method of claim 1 further comprising receiving updated metadata and not a new object in response to the sending of the freshness check, and updating the data in the web cache data structure based on the updated metadata.

6. The method of claim 1 further comprising receiving updated metadata and a new object in response to the sending of the freshness check, and updating the data in the web cache data structure based on the updated metadata, and updating the cache with the new object.

7. The method of claim 1 further comprising receiving updated metadata including freshness-related time data, and updating the data in the web cache data structure based on the freshness-related time data, while not updating metadata that indicates a client request was made for the object.

8. In a computer networking environment, a system comprising, a web proxy server that receives requests from a client for content directed towards a web server, the web proxy server including a cache for serving cached content in response to the client requests when corresponding content in the cache is valid, and the web proxy server including a freshness check mechanism that updates content in the cache independent of a pending client request for content.

9. The system of claim 8 wherein the freshness check mechanism sends an HTTP freshness request directed towards the web server upon detecting content in the cache that is not valid.

10. The system of claim 9 wherein the web proxy server receives updated metadata in response to the freshness check and updates a data structure based on the metadata.

11. The system of claim 10 wherein the web proxy server receives an object in response to the freshness check and stores the object in the cache.

12. The system of claim 8 wherein the content comprises a plurality of objects in the cache, wherein the web cache data structure contains data comprising an entry for each cached object, and wherein evaluating the data comprises scanning at least some of the entries upon a triggering event.

13. The system of claim 12 wherein the triggering event is time based.

14. A computer-readable medium having computer-executable instructions, comprising:
scanning stored metadata associated with cached web objects to determine whether corresponding cached web objects are invalid, including scanning for invalid objects without having pending client requests for those objects; and
when a cached web object is invalid, communicating with a web server to obtain new metadata indicating the cached object is not invalid, or receive a new object and new metadata in place of that cached object and that object's stored metadata.

15. The computer-readable medium of claim 14 wherein a cached web object is invalid, and having further computer-executable instructions comprising, obtaining metadata from the server indicating that the web object is not invalid, and updating at least part of the stored metadata with the new metadata.

16. The computer-readable medium of claim 14 wherein a cached web object is invalid, and having further computer-executable instructions comprising, receiving a new object and new metadata in place of that cached object and that object's stored metadata, updating at least part of the stored metadata with the new metadata, and storing the new object as a cached object.

17. The computer-readable medium of claim 14 having further computer-executable instructions comprising, repeating the scanning step at a later time.

18. The computer-readable medium of claim 17 wherein repeating the scanning step at a later time comprises delaying.

19. The computer-readable medium of claim 17 wherein repeating the scanning step at a later time comprises waiting for and receiving a triggering event.

20. The computer-readable medium of claim 14 wherein communicating with the web server comprises checking the freshness status of a plurality of web objects in a pipelined operation.
